(19) United States
(12) Patent Application Publication
(10) Pub. No.: US 2009/0070586 A1
(43) Pub. Date: Mar. 12, 2009

(54) Method, Device and Computer Program Product for the Encoded Transmission of Media Data Between the Media Server and the Subscriber Terminal

(76) Inventors: Wolfgang Bucker, Neubiberg (DE); Srinath Thiruvengadam, Donauworth (DE)

Correspondence Address: STAAS & HALSEY LLP, SUITE 700, 1201 NEW YORK AVENUE, N.W., WASHINGTON, DC, 20005, US

(21) Appl. No.: 12/223,803

(22) PCT Filed: Jan. 26, 2007
(86) PCT No.: PCT/EP2007/050792

§ 371 Date: Oct. 28, 2008

(30) Foreign Application Priority Data
Feb. 9, 2006 (DE) 10 2006 006 071.7

(51) Int. Cl. H04L 9/28

(52) U.S. Cl. 713/171

(57) ABSTRACT

A request is transmitted from a subscriber terminal via a control channel of an access network to an application function for determining a set of encoding parameters. An encoding context is generated by the application function in accordance with the set of encoding parameters. The encoding context is transmitted from the application function to a media server via a control interface of a core network. Either encoded media data are then decoded or unencoded media data are encoded by the media server using the encoding context in such a way that an encoded transmission of media data is carried out between the media server and the subscriber terminal. A network and a computer program are suitable for carrying out the method.

### CROSS REFERENCE TO RELATED APPLICATIONS

This application is based on and hereby claims priority to German Application No. 10 2006 006 071.7 filed on Feb. 9, 2006 and PCT Application No. PCT/EP2007/050792 filed on Jan. 26, 2007, the contents of which are hereby incorporated by reference.

### BACKGROUND

The invention relates to a method for transmitting media data via an access network. The invention also relates to a network and a computer program which are suitable for implementing the method.

Various methods, devices and systems are known for transmitting media data to or from a subscriber device via an access network. For example, the so-called H. standards (e.g. H.320, H.323, H.324) provide compression and control mechanisms for realtime transmission of audio and video data, in particular for video telephony.

Given the increasingly widespread use of broadband mobile radio networks, the Third Generation Partnership Project (3GPP) has developed a range of standards for integrating voice and Internet services under the name of IP Multimedia Subsystem (IMS). The IMS standards are intended to assist the amalgamation of packet-switching and line-switching networks, particularly in the field of mobile communications. However, IMS systems are also suitable for transmitting media data in fixed networks, e.g. via public telephone networks or the Internet.

When using mobile radio networks in accordance with the 3GPP UMTS Terrestrial Radio Access Network (UTRAN) standard, data is encrypted at the level of the security layer of the network protocol. As a result of this, the IMS Access Security (3GPP TS 33.203) and Network Domain Security (3GPP TS 33.210) standards do not provide for separate encryption of media data. However, such encryption of transmitted data does not take place in fixed networks.

However, encryption of media data is often desired. Firstly because IP-based networks in particular are notoriously insecure, and therefore e.g. video-telephone calls which are routed at least partially via IP networks can be eavesdropped relatively easily. Secondly media data is often offered in the form of so-called value-added services, e.g. video-on-demand, in which case the recipient must pay for transmitted data. In this context, it is again necessary to ensure that the transmitted media data is only used by the legitimate recipient.

The standard ETSI TS 133 246 V6.5.0 Release 6 (“Security of Multimedia Broadcast/Multicast Service (MBMS)”) discloses a method for transmitting encrypted media data from a Broadcast-Multicast Service Center to a subscriber device. A standard for the secure transmission of media data between two subscribers is known from the Secure Realtime Transport Protocol (SRTP as per RFC 3711). However, data transmission as per the SRTP standard cannot be utilized in heterogeneous networks in particular. This is partly because technical problems relating to the conversion of encrypted data streams can occur at network boundaries, e.g. at the transition from the Internet to public telephone networks. Secondly, statutory regulations must be observed, e.g. governing State surveillance of telephone calls. Furthermore, a direct exchange of keys between two subscribers is often problematic if there is no relationship of trust between them.

### SUMMARY

One potential object is therefore to describe a method and a network which allow encryption of media data in an access network. In this case, the intention is to protect in particular a transmission between an exchange in a line-based network and a subscriber in the line-based network.

The inventors propose a method for transmitting media data, wherein said method comprises the following steps:
transmitting a request from a subscriber device via a control channel of an access network to an application function in order to determine a set of encryption parameters,
generating an encryption context depending on the set of encryption parameters by the application function,
transmitting the encryption context from the application function to a media server via a control interface of a core network,
encrypting unencrypted media data by the media server using the encryption context, and
transmitting the encrypted media data from the media server via a data channel of the access network to the subscriber device.

According to the method, a set of encryption parameters is initially transmitted or negotiated via a control channel from the subscriber device to an application function. This operation can be executed e.g. when a connection from the subscriber device is set up. On the basis of the transmitted set of encryption parameters, the application function generates an encryption context which is suitable for encrypting media data. In a further step, this encryption context is transmitted via a control interface of a core network to a media server, such that the media server can encrypt media data which it sends to the subscriber device in a further step. For this purpose, the media server and the subscriber device do not need to negotiate an individual key for encrypting the media data.

Likewise a decryption of encrypted media data is carried out by the media server using the encryption context.

In this way, media data which is transmitted via the access network in the opposite direction is also protected by encryption, without a direct exchange of keys between the media server and the subscriber device being required for this purpose.

According to an advantageous embodiment, the set of encryption parameters is generated by the subscriber device using a first key and is checked by the application function using a second key.

As a result of encryption parameters being generated depending on the first key of the subscriber device, the subscriber device can also be authenticated by the second key at the same time as the encryption context is generated.

According to a further advantageous embodiment, the subscriber device and the application function are configured for implementing a session initiation protocol, and the set of encryption parameters is determined by exchanging messages in accordance with the session initiation protocol.

A subscriber device and an application function which are configured for implementing session initiation protocols, these being used e.g. to authenticate a subscriber device in relation to an exchange, can also use such protocols for the purpose of determining the set of encryption parameters.

According to a further advantageous embodiment, the method additionally comprises the steps of checking an authentication of the subscriber device by the application function and transmitting authentication data from the application function to the media server via the control interface.

As a result of authentication data being checked and transmitted by the application function, it is possible to ascertain whether a subscriber device is authorized to receive media data.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a network comprising two subscriber devices and an exchange,

FIG. 2 shows a sequence diagram for a transmission of media data between a first subscriber device and a second subscriber device,

FIG. 3 shows a flow diagram in accordance with an embodiment of a method for transmitting media data.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

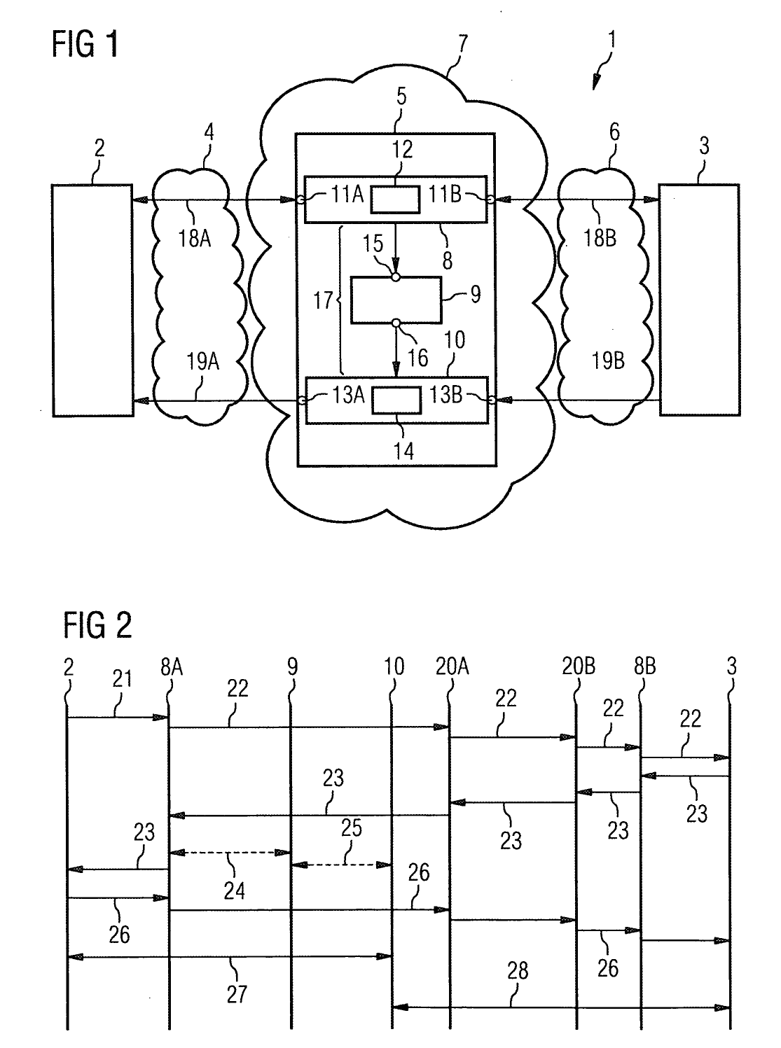

FIG. 1 shows a network 1 comprising a first subscriber device 2, a second subscriber device 3 and an exchange 5.

The first subscriber device 2 is connected to the exchange 5 via a first access network 4. The second subscriber device 3 is likewise connected to the exchange 5 via a second access network 6.

The exchange 5 is situated in a core network 7 and comprises an application function 8, a decision function 9 and a media server 10.

The application function 8 has two first interfaces 11A and 11B to the first subscriber device 2 or the second subscriber device 3 respectively. The application function 8 also has a key unit 12. The key unit 12 is used inter alia for generating, negotiating or checking session keys.

The media server 10 has two second interfaces 13A and 13B, via which the media server 10 is connected to the first subscriber device 2 or the second subscriber device 3 respectively. The media server 10 also has a second encryption unit 14 which is suitable for encrypting or decrypting media data.

The application function 8 is connected to the decision function 9 via a third interface 15. The decision function 9 is connected to the media server 10 via a fourth interface 16. The third interface 15, the decision function 9 and the fourth interface 16 together form a control interface 17, via which the media server 10 can be controlled by the application function 8.

In the case of IMS, the application function 8 does not provide any applications itself, but controls the resources which are required for an application. For example, during a connection setup phase, the application function 8 and the decision function 9 can together reserve transmission capacities in the core network 7, which are used by the media server 10 for the transmission of media data during a subsequent transmission phase.

The first access network 4 comprises a control channel 18A between the first subscriber device 2 and the first interface 11A of the application function 8, and a data channel 19A between the second interface 13A of the media server 10 and the first subscriber device 2. The second access network 6 likewise comprises a control channel 18B between the second subscriber device 3 and the first interface 11B, and a data channel 19B between the second interface 13B and the second subscriber device 3.

Both the control channels 18 and the data channels 19 are suitable for bidirectional communication in the exemplary embodiment shown. In principle, however, it is also feasible for communication to be possible in one direction only, or for communication for different data flow directions to run on different transmission channels 18 or 19.

The control channel 18 and the data channel 19 can be e.g. data connections on different protocol levels on a single transmission channel between the exchange 5 and the subscriber devices 2 or 3, or separate transmission channels such as e.g. a so-called ISDN control channel D and a so-called ISDN data channel B.

For the sake of simplicity, FIG. 1 shows the first subscriber device 2 and the second subscriber device 3 connected to a single exchange 5. The core network 7 can have a multiplicity of exchanges 5, however, wherein the first subscriber device 2 is attached to a first exchange and the second subscriber device 3 to a second exchange. It is also possible that additional intermediate networks exist between the first subscriber device 2, the exchange 5 and the second subscriber device 3, but these are likewise not shown in FIG. 1.

The first access network 4 is e.g. a line-based public telephone network such as an analog telephone network or a digital ISDN telephone network, for example. The second access network 6 is e.g. a wireless mobile radio network such as a GSM or UMTS network, for example. The core network 7 is e.g. a data network as per the Internet protocol (IP), which is used by a communication services provider for internal data transmission.

In the described exemplary embodiment, a connection is to be created between the first subscriber device 2 and the second subscriber device 3 via the exchange 5. In this case, media data such as e.g. a combined audio and video stream is to be exchanged in real time between the first subscriber device 2 and the second subscriber device 3.

Because the first access network 4 is a line-based telephone network, the media data which is transmitted from the media server 10 via the data channel 19A to the first subscriber device 2 is to be encrypted. The media data which is transmitted from the second subscriber device 3 to the media server 10 via the data channel 19B need not be encrypted in the present example, because the second access network 6 is a radio network in which encryption is already utilized on the security level of the network protocol. However, an equivalent method for encrypted data transmission can also be applied in the second access network 6.

FIG. 2 shows a sequence diagram for a connection setup and a subsequent transmission of media data between the first subscriber device 2 and the second subscriber device 3.

In an IMS, a so-called Proxy Call Session Control Function (P-CSCF) which represents the first contact point of the first subscriber device 2 in the core network 7 assumes the functionality of a first application function 8A for the first subscriber device 2. A separate P-CSCF is assigned to the second subscriber device 3 and acts as a second application function 8B for this second subscriber device 3. Monitoring functions 20A and 20B which are known as Serving Call Session Control Functions (S-CSCF) are also arranged therebetween and monitor the services for the first subscriber device 2 or the second subscriber device 3.

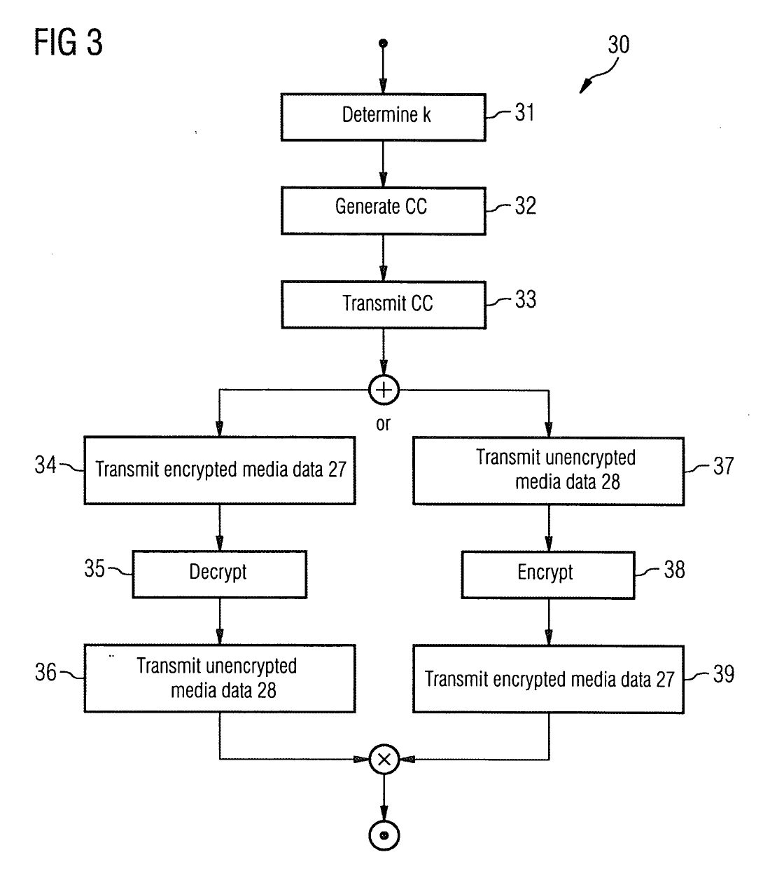

The exemplary data transmission according to FIG. 2 is explained in greater detail with reference to a flow diagram which is illustrated in FIG. 3. FIG. 3 shows a method 30 for transmitting media data.

In a step 31, a set of encryption parameters k which specifies an encryption that must be used is determined between the first subscriber device 2 and the first application function 8A.

For example, the first subscriber device 2 can generate a session key on the basis of a private key of the first subscriber device 2 and transmit this to the first application function 8A. In principle, a multiplicity of different methods for generating encryption parameters k for symmetrical or asymmetrical communication, said methods being known to a person skilled in the art, can be used in connection with the described method 30 for transmitting media data.

In the step 31, further encryption parameters, which e.g. determine a length of a key that is to be used, can also be specified by the first subscriber device 2 or negotiated between the first subscriber device 2 and the first application function 8A with the aid of a session initiation protocol. As a session initiation protocol, it is possible to utilize e.g. the so-called Session Initiation Protocol (SIP, corresponding to RFC 3261 and RFC 2543) in conjunction with the Session Description Protocol (SDP, corresponding to RFC 2327). It is also possible for some or all encryption parameters to be determined by the first application function 8A and transmitted to the first subscriber device 2.

In accordance with the SIP protocol, a message exchange which serves to register the subscriber device takes place between the subscriber device 2 and the first application function 8A first, but is not shown in the FIG. 2. A request 21 is then transmitted from the subscriber device 2 to the first application function 8A. In the exemplary embodiment, a set of encryption parameters k is integrated in the request 21 which, in addition to the set of encryption parameters k, contains further data such as e.g. a destination address for setting up a connection. For example, it can be a so-called Invite Request as per the Session Initiation Protocol. This protocol is similar to the Hyper Text Transfer Protocol (HTTP) and is suitable for setting up communication sessions via data networks, in particular for setting up voice connections in so-called voice-over-IP (VoIP) networks, for example. Authentication of the subscriber device 2 can also take place during this phase, e.g. by having authentication data verified by a so-called Home Subscriber Server (HSS) which, however, is not illustrated in FIG. 1.

It can be seen in FIG. 2 that the request 21 is first transmitted from the first subscriber device 2 to the first application function 8A in the exemplary embodiment shown. A protocol which is suitable for transmitting or negotiating key information is used by the first subscriber device 2 and the first application function 8A in this case. For example, the set of encryption parameters k can be transmitted via the Multimedia Internet KEYing (MIKEY, corresponding to RFC 3830) protocol as payload data of an SDP request via the SIP protocol to the first application function 8A. In this way, the first application function 8A receives the set of encryption parameters k of the request 21.

Further parts of the request 21, which do not relate to the encryption, are forwarded to the first monitoring function 20A in the form of a modified request 22. According to the IMS protocol, the core network 7 comprises an S-CSCF for the first subscriber 2 and the second subscriber 3 respectively, which forwards the modified request 22 from the first application function 8A to the second application function 8B in order to set up a connection with the second subscriber device 3.

If the second subscriber device 3 is ready to answer the modified request 22, the second subscriber device 3 sends a response 23 which is transmitted back in the opposite direction to the first application function 8A. In the context of the SIP protocol, said response in this case comprises e.g. the reply code “200 OK” and other messages which, however, are not shown in the FIG. 2 for the sake of simplicity.

In a further step 32, the first application function 8A generates an encryption context CC which is based on the set of encryption parameters k that was determined in the step 31. The encryption context CC comprises e.g. an encryption algorithm that is to be used, a key that is to be used for the encryption, and further parameters that are required for carrying out an encryption correctly.

The generated encryption context CC is transmitted from the first application function 8A to the media server 10 in the step 33.

In the arrangement which is illustrated in FIG. 1, the generated encryption context CC is first transmitted from the application function 8 to the decision function 9. For this purpose, the encryption context CC is transmitted via the third interface 15 which, in the exemplary embodiment, is a so-called Gq interface as specified by 3GPP standards or a Gq′ interface as specified by the Next Generation Network (NGN) of the Telecommunications and Internet converged Services and Protocols for Advanced Networking (TISPAN) project group of the European Standards Institute (ETSI) as per the Diameter protocol (RFC 3588).

The Diameter protocol is suitable for transmitting so-called attribute-value-pairs. The first application function 8A must therefore encode the encryption context CC in a set of attribute-value-pairs as a first encoded encryption context 24. In this case, either existing attributes can be used for the purpose of transmitting the encryption context CC, or new attributes can be introduced by the first application function 8A.

The decision function 9, which is called the Service Based Policy Decision Function (SPDF or PDF) in the TISPAN or 3GPP standard, decodes the transmitted first encoded encryption context 24 and transmits the information which is contained therein as a second encoded encryption context 25 via the fourth interface 16 to the media server 10. In the exemplary embodiment, the fourth interface 16 according to the TISPAN standard is a so-called Ia interface as per the H.248 protocol.

After the transmission of the encryption context CC from the first application function 8A to the media server 10, the first application function 8A forwards the response 23 to the first subscriber device 2. In accordance with the 3GPP protocol TS24.229, the first subscriber device 2 confirms to the first application function 8A that the connection has been set up, this being done by a confirmation message 26 which is also forwarded to the second subscriber device 3.

In a further step 34, the first subscriber device 2 transmits encrypted media data 27 to the media server 10 or the media server 10 transmits encrypted media data 27 to the first subscriber device 2.

Using the set of encryption parameters k, the first subscriber device 2 can generate an encryption context CC which is equivalent to that which was transmitted to the media server 10 in the step 33. As a result, both the first subscriber device 2 and the media server 10 are in a position to encrypt or decrypt media data. Particularly in the case of substantial data streams, such as those arising in the context of videotelephony, for example, symmetrical encryption methods are suitable for this purpose. A data stream can be associated with a sufficiently long key by an XOR function, for example.

In the data flow diagram illustrated in FIG. 2, the encrypted media data 27 flows from the first subscriber device 2 to the media server 10. The media server 10 which itself possesses the encryption context CC can decrypt the received encrypted media data 27 and generates unencrypted media data 28 in the step 35 in this way.

The unencrypted media data 28 is transmitted from the media server 10 to the second subscriber device 3 in a step 36.

As shown in FIG. 3, a data flow in the opposite direction, i.e. from the second subscriber device 3 to the first subscriber device 2, is also possible. In this case, unencrypted media data 28 is first transmitted to the media server 10 in the step 37. In a further step 38, the media server 10 encrypts the unencrypted media data 28 and thus generates encrypted media data 27. The encrypted media data 27 is transmitted to the first subscriber device 2 in the step 39.

In the case of bidirectional communication applications such as videotelephony, both of the above described variants are often used in parallel, such that outgoing encrypted media data 27 from the first subscriber device 2 is decrypted by the media server in the step 35, and unencrypted media data 28 destined for the first subscriber device 2 is simultaneously encrypted by the media server 10 in the step 38.

Other application possibilities include e.g. the transmission of predefined media data in one direction only, e.g. from the media server 10 to the first subscriber device 2. For example, a video-on-demand platform which is present in the core network 7 but is not shown in the FIG. 1 can transfer unencrypted media data 28 to the media server 10. The media server 10 encrypts the desired media data 28 in the step 38 and transfers it as encrypted media data 27 to the first subscriber device 2.

Instead of the exchange 5, provision can also be made for a so-called communication gateway which e.g. transmits media data from a line-switching access network 4 to a packet-switching network such as e.g. the core network 7 or the second access network 6. In particular, this allows switching between hardware telephones and software telephones or telephone applications. In this case, both the data formats and protocols of the control channel 18A and 18B or the data channel 19A and 19B can differ, such that conversion of the different protocols by the application function 8 or the media server 10 is required. Particularly in such application scenarios, it is advantageous if encryption is only to be utilized on one of the access networks 4 or 6.

Encrypted transmission of media data between the second subscriber device 3 and the media server 10 is also possible. In this case, the second subscriber device 3 itself transmits an encryption parameter k to the second application function 8B which is assigned to it. In this way, exclusively encrypted media data 27 is exchanged via the data channels 19A and 19B, without a relationship of trust between the first subscriber device 2 and the second subscriber device 3 being required for this.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for transmitting media data, comprising:
generating a set of encryption parameters at a subscriber device using a first key;
transmitting a request from the subscriber device to an application function, the request including the set of encryption parameters;
generating an encryption context at the application function depending on the set of encryption parameters, the encryption context including a second key which is to be used for the encryption;
transmitting the encryption context from the application function to a media server via a control interface of a core network;
encrypting unencrypted media data at the media server using the second key to thereby generate encrypted media data; and
transmitting the encrypted media data from the media server via a data channel of an access network to the subscriber device.

12. The method as claimed in claim 11, further comprising:
checking the set of encryption parameters at the application function using the second key.

13. The method as claimed in claim 11, wherein
the subscriber device and the application function are configured for a session initiation protocol, and
the set of encryption parameters is determined by exchanging messages in accordance with the session initiation protocol.

14. The method as claimed in claim 11, further comprising:
checking an authentication of the subscriber device using the application function, and
transmitting authentication data from the application function to the media server via the control interface.

15. The method as claimed claim 11, wherein
the control interface which is configured for transmitting]transmits value pairs, and
the encoded encryption context comprises a set of value pairs.

16. The method as claimed in claim 12, wherein
the subscriber device and the application function are configured for a session initiation protocol, and
the set of encryption parameters is determined by exchanging messages in accordance with the session initiation protocol.

17. The method as claimed in claim 16, further comprising:
checking an authentication of the subscriber device using the application function, and
transmitting authentication data from the application function to the media server via the control interface.

18. The method as claimed claim 17, wherein
the control interface which is configured for transmitting]transmits value pairs, and
the encoded encryption context comprises a set of value pairs.

19. A method for transmitting media data, comprising:
generating a set of encryption parameters at a subscriber device using a first key;
transmitting a request from the subscriber device to an application function, the request including the set of encryption parameters;
generating an encryption context at the application function depending on the set of encryption parameters, the encryption context including a second key which is to be used for the encryption;
transmitting the encryption context from the application function to a media server via a control interface of a core network;
transmitting encrypted media data from the subscriber device via a data channel of an access network to a media server; and
decrypting the encrypted media data at the media server using the second key.

20. The method as claimed in claim 19, further comprising:
checking the set of encryption parameters at the application function using the second key.

21. The method as claimed in claim 19, wherein
the subscriber device and the application function are configured for a session initiation protocol, and
the set of encryption parameters is determined by exchanging messages in accordance with the session initiation protocol.

22. The method as claimed in claim 19, further comprising:
checking an authentication of the subscriber device using the application function, and
transmitting authentication data from the application function to the media server via the control interface.

23. The method as claimed claim 19, wherein
the control interface which is configured for transmitting]transmits value pairs, and
the encoded encryption context comprises a set of value pairs.

24. The method as claimed in claim 20, wherein
the subscriber device and the application function are configured for a session initiation protocol, and
the set of encryption parameters is determined by exchanging messages in accordance with the session initiation protocol.

25. The method as claimed in claim 24, further comprising:
checking an authentication of the subscriber device using the application function, and
transmitting authentication data from the application function to the media server via the control interface.

26. The method as claimed claim 25, wherein
the control interface which is configured for transmitting]transmits value pairs, and
the encoded encryption context comprises a set of value pairs.

27. A network comprising:
an application unit comprising a first interface and a key unit, the key unit generating, negotiating and/or checking session keys, the first interface interfacing with an access network;
a media server comprising an encryption unit and a second interface to the access network; and
a core network comprising a control interface via which the application unit is operatively connected to the media server, wherein
a subscriber device is connected via a control channel of the access network to the first interface of the application unit and via a data channel to the second interface of the media server,
the key unit is configured to analyze a request which includes a set of encryption parameters from the subscriber device,
the key unit generates an encryption context including a key that is used for encryption, the encryption context being generated based on the set of encryption parameters,
the key unit has a transmitter to transmit the encryption context via the control interface to the encryption unit, and
the encryption unit is configured to decrypt encrypted media data which is received from the second interface using the key of the encryption context, or to encrypt unencrypted media data using the key of the encryption context and providing encrypted media data via the second interface.

28. The network as claimed in claim 27, wherein
the control interface has a decision unit which enables or disables access to individual services of the core network,
the application unit is connected via a third interface to the decision unit, and
the decision unit is connected via a fourth interface to the media server.

29. The network as claimed in claim 27, wherein the network is an IP multimedia subsystem.

30. A computer readable storage medium storing a program, which when executed on a computer causes the computer to perform a method for transmitting media data, comprising:
generating a set of encryption parameters at a subscriber device using a first key;
transmitting a request from the subscriber device to an application function, the request including the set of encryption parameters;
generating an encryption context at the application function depending on the set of encryption parameters, the encryption context including a second key which is to be used for the encryption;
transmitting the encryption context from the application function to a media server via a control interface of a core network;
encrypting unencrypted media data at the media server using the second key to thereby generate encrypted media data; and
transmitting the encrypted media data from the media server via a data channel of an access network to the subscriber device.
